(19) United States
(12) Patent Application Publication
(10) Pub. No.: US 2026/0216990 A1
(43) Pub. Date: Jul. 30, 2026

(54) High Strength Composite Structures and Methods of Production

(71) Applicant: Colin Coleman, Okehampton (GB)

(72) Inventor: Colin Coleman, Okehampton (GB)

(21) Appl. No.: 19/569,718

(22) Filed: Mar. 17, 2026

Related U.S. Application Data
(63) Continuation-in-part of application No. 19/032,755, filed on Jan. 21, 2025.
(60) Provisional application No. 63/560,992, filed on Mar. 4, 2024.

(51) Int. Cl. B32B 5/26; B32B 3/04; B32B 3/12; B32B 5/02; B32B 7/12; B32B 15/20

(52) U.S. Cl. CPC B32B 5/262; B32B 3/04; B32B 3/12; B32B 5/024; B32B 7/12; B32B 15/20; B32B 2260/021; B32B 2260/046; B32B 2262/0269; B32B 2262/106; B32B 2307/306; B32B 2307/558

(57) ABSTRACT

A lightweight, high-strength, heat-resistant composite structure and method of fabrication are described. The structure comprises a substrate enclosed by an inner casing carbon fiber layers, and an outer housing of aramid fabric layers. Additional configurations may include interspersed layers of carbon and aramid fabrics within the casings for enhanced properties. An optional outer protective layer, such as a surface guard tape, provides resistance to UV light, abrasion, and environmental factors. The substrate can be flat, shaped, solid or semi-solid, and made from materials like polypropylene or TPU, enabling applications in panels, cargo containers, fan blades, and airfoils. The manufacturing process involves layered fabric layups in a two-part mold, followed by curing under heat, pressure, or time to produce the final structure. In further embodiments, the carbon fiber fabric and aramid fabric are pre-impregnated with resin.

### CROSS-REFERENCE TO RELATED APPLICATIONS

This application is a continuation-in-part application of US patent application US 19/032,755 filed on 1/21/2025 entitled “High Strength Composite Structure and Method of Production”, that in turn claims priority to US 63/560,992 filed on 3/4/2024 entitled “Inexpensive Impact Resistant Shell and Method of Production” the contents of both of which are hereby fully incorporated by reference.

### BACKGROUND OF THE INVENTION

The invention relates to composite structures and more particularly to lightweight, high strength, heat resistant composite structures and most particularly to such structures made of a combination of carbon fiber fabrics and aramid fabrics.

Carbon fiber structures offer many benefits, such as high strength-to-weight ratio, corrosion resistance, and excellent rigidity. However, they have some shortcomings that can affect their suitability for certain applications. Carbon fiber is strong in tension but can be brittle and prone to sudden failure under certain types of loading, such as impact or sharp bending. For instance, it is less resistant to impact damage than metals.

Aramid fabrics such as, but not limited to, Kevlar™ and Twaron™ are, on the other hand, highly impact resistant. Aramid fibers have exceptional tensile strength, which allows them to absorb and distribute the energy from impacts across a wide area, reducing the likelihood of catastrophic failure. Aramid fibers also offer exceptional heat and flame resistance, withstanding temperatures over 500 degrees Celsius without melting or igniting.

What is desirable are structures that may combine the beneficial properties of both carbon fiber fabrics and aramid fabrics, without introducing undesirable shortcomings.

### SUMMARY OF THE INVENTION

Inventive light weight, high strength, heat resistant composite structures and methods of making them are disclosed. The composite structures of the present invention may, for instance, have strength-to-weight ratios that are significantly superior, i.e., by a factor of 2 to 5, compared to that of aluminum.

In a preferred embodiment, the composite structure may comprise a lightweight substrate that may be enclosed by an inner, strength providing, casing consisting of one or more layers of carbon fiber fabric. There may then be an outer housing enclosing the inner casing that may provide heat and impact resistance. The outer housing may, for instance, consist of one or more layers of aramid fabric.

The composite structure may also have an outer protective layer of surface guard tape that may be polyurethane film, commonly referred to as “helicopter tape, applied over it. Such a layer may, for instance, protect the structure against undesirable environmental elements such as, but not limited to, UV light, mild abrasion and acids.

The lightweight substrate or core may, for instance, be a flat sheet or a lattice made of a material or polymer such as, but not limited to, a polypropylene, a PETG (Polyethylene Terephthalate Glycol). Nylon, a TPU (Thermoplastic Polyurethane) and Acrylonitrile butadiene styrene (ABS). These materials typically have densities in a range of 0.90 to 1.45 g/cm³ which is significantly less than the 2.7 gm/cm3 of Aluminum, and may therefore be considered lightweight even when in solid form. Such an enclosed substrate may result in a light weight, high strength, heat resistant composite panel or sheet. Such panels may be joined together to form structures such as, but not limited to, cargo containers or pallets for vehicles such as, but not limited to, aircraft.

The lightweight substrate may, for instance, provide a structural shape and may be solid or fully or partially hollow and may consist of pattern such as, but not limited to, a lattice or honeycomb structure that may be produced by a method such as, but not limited to, additive manufacture or 3D printing of a suitable material such as, but not limited to, a polymer or metal.

The structural shape may, for instance, be a sufficiently complex shape such as may be necessary to produce components such as, but not limited to, fan blades, airfoils and propellor blades.

The composite structure may, for instance, be made using suitable two part, or clam shell, molds that may be shaped to match or enclose the lightweight polymer substrate. The manufacturing process may then proceed by laying up one or more layers of aramid fabric onto a lower part of the two-part mold to create a lower, outer housing. After that, a lower inner casing may be formed by laying up one or more layers of carbon fiber fabric to create a lower inner casing. The polymer core may then be placed onto the lower inner casing, after which one or more layers of carbon fiber fabric may be laid on to create an upper inner casing. Then an upper, outer housing may be created by laying up one or more layers of aramid fabric onto upper inner casing, at which point a laid up composite structure may have been completed. The two-part mold may then be reformed by placing the upper part the mold to connect with the lower part while enclosing the laid up laminated structure. The two-part mold containing the laid up laminated structure may then be cured while contained In the two-part mold. The curing may, for instance, be accomplished by suitable heating, pressure or time, or some combination thereof. After curing is completed, the mold may be separated and the cured composite structure removed.

As each fabric layer is applied, a suitable binding agent or resin may be applied. Alternately, one or more of the fabric layers may be resin impregnated layers, or cured resin impregnated layers.

Therefore, the present invention succeeds in conferring the following, and others not mentioned, desirable and useful benefits and objectives.

It is an object of the present invention to provide an inexpensive light weight, high strength, heat resistant composite structure.

It is another object of the present invention to produce light weight, high strength, heat resistant composite panels that may be used to build more complex structures.

### BRIEF DESCRIPTION OF DRAWINGS

FIG. 1 shows a cross-sectional view of a lightweight, high strength, heat resistant composite structure of the present invention.

FIG. 2 shows A cross-sectional view of a further embodiment of a lightweight, high strength, heat resistant composite structure of the present invention.

FIG. 3 shows a cross-sectional view of yet another embodiment of a lightweight, high strength, heat resistant composite structure of the present invention.

FIG. 4 shows A cross-sectional view of yet a further embodiment of a lightweight, high strength, heat resistant composite structure of the present invention.

FIG. 5 shows a schematic cross-sectional view of two-part mold containing a laid up composite structure.

FIG. 6 is a flow diagram 600 showing representative steps of one method of creating a lightweight, high strength, heat resistant composite structure of the present invention.

FIG. 7 shows a cross-sectional view of yet another embodiment of a light weight, high strength, heat resistant composite structure.

### DETAILED DESCRIPTION OF THE INVENTION

The preferred embodiments of the present invention will now be described with reference to the drawings. Identical elements in the various figures are identified, in so far as possible, with the same reference numerals. The embodiments that are described in detail are provided by way of explanation of the present invention, which is not intended to be limited thereto. In fact, those of ordinary skill in the art may appreciate upon reading the present specification and viewing the present drawings that various modifications and variations can be made thereto.

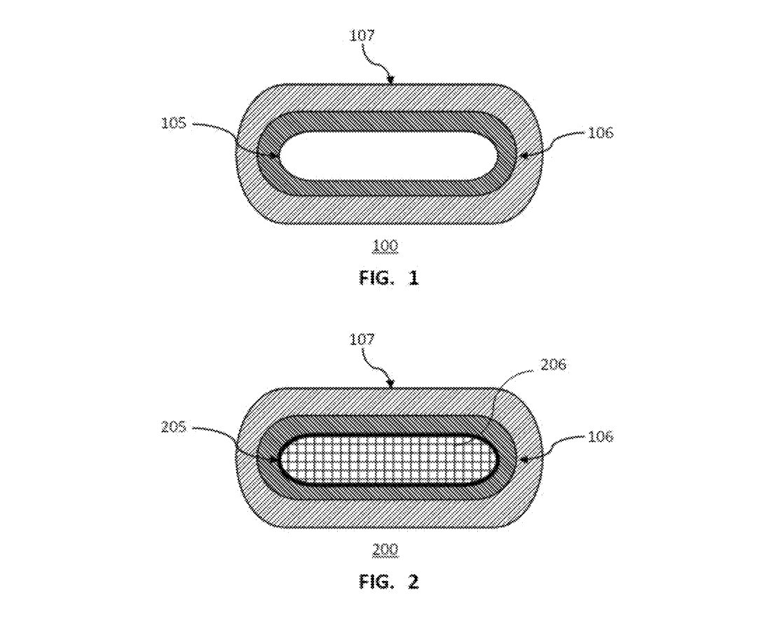

FIG. 1 shows a cross-sectional view 100 of a lightweight, high strength, heat resistant composite structure of the present invention.

The structure may consist of a substrate 105 surrounded by an inner, strength providing casing 106 and an outer housing 107 providing heat and impact resistance. The composite structures of the present invention may, for instance, have strength-to-weight ratios that are significantly superior, i.e., by a factor of 2 to 5, to that of aluminum.

The substrate 105 may, for instance, be made of a suitable lightweight material such as, but not limited to, a polypropylene, a PETG (Polyethylene Terephthalate Glycol), Nylon, a TPU (Thermoplastic Polyurethane), Acrylonitrile butadiene styrene (ABS) and balsa wood, or some combination thereof. These materials typically have densities in a range of 0.90 to 1.45 g/cm³ which is significantly less than the 2.7 gm/cm³ density of Aluminum, and may therefore be considered lightweight even when in solid form. The material may be formed to an appropriate or required shape by any suitable well known machining process such as, but not limited to, 3D printing, additive manufacturing, milling, casting, or some combination thereof.

The substrate may, for instance, be uniformly solid, or partially solid, and may be wholly or partly 3D-printed or made by additive manufacture.

The inner, strength providing, casing 106 may, for instance, be made up of one or more layers 309 of carbon fiber fabric (See FIG. 3). Carbon fiber structures are well known for their high strength-to-weight ratio, corrosion resistance, and excellent rigidity. However, while carbon fiber is strong in tension it may be brittle and therefore less resistant to impact damage than other materials such as metals. An impact resistant outer layer to protect the carbon fiber layers may therefore be desirable.

Such an outer housing 107 providing heat and impact resistance may, for instance, be fabricated using one or more layers 305 of aramid fabric (See FIG. 3).

Aramid fabrics such as, but not limited to, Kevlar™ and Twaron™ are well known for being highly impact resistant. Aramid fibers have exceptional tensile strength, which may allow them to absorb and distribute energy from impacts across a wide area, reducing the likelihood of catastrophic failure. Kevlar™ is manufactured by DuPont de Nemours, headquartered in Wilmington, DE. Twaron is made by Teijin Twaron, B.V. which is based in Arnhem, The Netherlands.

Carbon fiber fabrics are manufactured by a variety of companies such as Hexcell Corporation, headquartered in Stamford, CT.

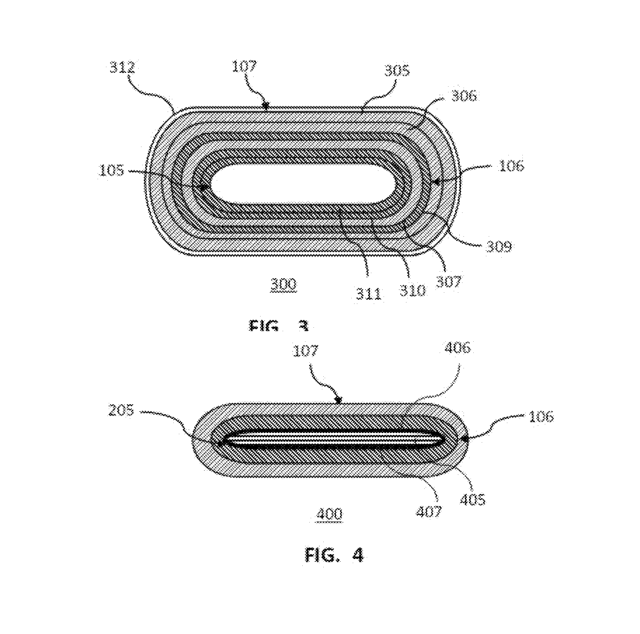

FIG. 2 shows a cross-sectional view 200 of a further embodiment of a lightweight, high strength, heat resistant composite structure of the present invention.

As shown in FIG. 2, the composite structure may comprise an outer housing 107 that may provide heat and impact resistance that may be made up of one or more layers of aramid fabric. The outer housing may enclose an inner, strength providing, casing 106 that may be made up of one or more layers of carbon fiber fabric. This in turn may enclose a shaped substrate 205.

The shaped substrate 205 may be a lattice 206 such as, but not limited to, a honeycomb structure. The shaped substrate may be made using any suitable manufacturing technique such as, but not limited to, 3D printing, additive manufacturing, milling, casting, or some combination thereof. The shaped substrate may, for instance, be partially hollow.

FIG. 3 shows a cross-sectional view 300 of yet another embodiment of a lightweight, high strength, heat resistant composite structure of the present invention.

As shown in FIG. 3, the outer housing 107 may consist of a first layer 305 and a second layer 306 of aramid fabric.

The inner casing 106 may consist of first layer 309 of carbon fiber fabric followed by a third layer 307 of aramid fabric. This third layer 307 of aramid fabric may be interspersed between two layers of carbon fiber fabric, namely the first layer 309 of carbon fiber fabric and the second layer 310 of carbon fiber fabric. There may also be a third layer 311 of carbon fiber fabric that may be enclosing the substrate 105.

The composite structure may also be surrounded by an outer protective coating 312. This may, for instance, be a protective layer of surface guard tape that may be polyurethane film, commonly referred to as “helicopter tape”. This final outer layer may be coated on an inner surface with a pressure sensitive adhesive to allow easy application. This final outer layer may protect the structure against undesirable environmental elements such as, but not limited to, UV light, mild abrasion and acids.

One of ordinary skill in the art may appreciate that although FIG. 3 shows a particular interleaving of aramid/carbon fiber fabric layers, many alternate arrangements of interleaving may be envisaged. One purpose of having a layer of aramid interspersed between two layers of carbon fiber may be to allow impact protection of the innermost layers of carbon fiber in the event of a breach of the outermost layer of carbon fiber.

An alternative way of describing FIG. 3 may be to say that outer housing consists of at least one layer of carbon fiber fabric interspersed between two layers of aramid fabric.

One of ordinary skill in the art may appreciate that in the descriptions above, any or all of the layers of carbon fiber fabric may, instead, be resin impregnated carbon fiber fabric, or cured resin impregnated carbon fiber fabric. Similarly, any or all of the layers of aramid fabric layers may, instead be, resin impregnated aramid fabric layers, or cured resin impregnated aramid fabric layers.

The nature of the final light weight, high strength, heat resistant composite structure may depend on the shape of the substrate. For instance, if the substrate is a flat sheet the final result may be a light weight, high strength, heat resistant composite panel or sheet. Such panels may be joined together to form structures such as, but not limited to, cargo containers for aircraft. For instance, such panels of composite materials of the present invention may replace some or all of the aluminum parts described in for instance US Patent US 4,690,360. US 4,690,360 entitled “Cargo pallet” issued to Robert Looker on September 01, 1987, describes the construction of a cargo pallet for use in transporting cargo in aircraft, and the contents of which are hereby incorporated by reference in their entirety.

Alternately, the substrate may have a more complex shape and may be used to produce structures such as, but not limited to, fan blades, airfoils and propellor blades. The more complex substrate may, for instance, be solid, hollow, or partially solid and hollow.

When laying up the carbon fiber fabric for more complex shapes having curves, the choice of carbon fiber fabric may be important as different weaves have different draping characteristics. For instance, the best weaves for draping are weaves such as, but not limited to, a satin weaves, a twill weave, or a bi-directional weave with fine wefts. Due to cost considerations, a preferred choice of carbon fiber fabric for a relatively complex structure such as, but not limited to, a fan or propellor blade may be a twill weave carbon fiber fabric.

FIG. 4 shows a cross-sectional view 400 of yet a further embodiment of a light weight, high strength, heat resistant composite structure of the present invention.

As shown in FIG. 4, an outer housing 107 providing heat and impact resistance surrounds an inner, strength providing casing 106. The inner casing in turn enclosed a shaped substrate 205. The substrate may comprise one or more layers 405 of foil. The layers of foil may, for instance, be layers such as, but not limited to, a polymer foil, a layer of carbon fiber, an aluminum foil and an iridium foil, or some combination thereof.

Each or any of the layers of foil or film may further have an adhesive coating on at least an upper 406 or a lower 407 surface of the layer of foil or film, or on both surfaces. The adhesive coating may, for instance, be a pressure sensitive adhesive such as, but not limited to, an acrylate polymer, natural rubber, a synthetic thermoplastic elastomer, and a silicone rubber, or some combination thereof.

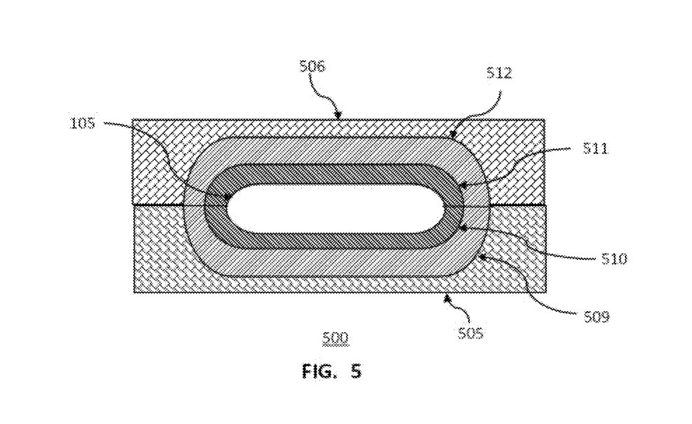

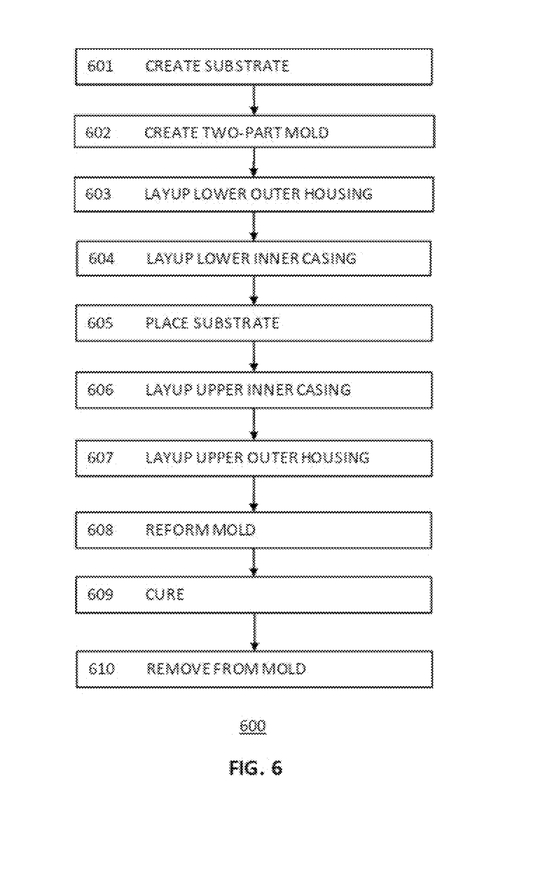

FIG. 5 shows a schematic cross-sectional view 500 of two-part mold containing a laid up composite structure.

The two-part mold may be shaped to enclose the substrate 105 and the layers of aramid and carbon fiber surrounding it. As shown the two-part, or claim shell, mold may consist of a lower part 505 and an upper part 506.

In the manufacturing process, the lower, outer housing 509 of aramid fabric may be laid up first on the inner surface of the lower part of the mold , followed by the lower inner casing 510 of carbon fiber fabric. The substrate 105 may then be added, or placed on top of lower, inner housing 510 of carbon fiber fabric after which the upper inner casing 511 of carbon fiber fabric may be added. Next the upper, outer housing 512 of aramid fiber layers may be added. Finally, the upper part 506 of the two-part mold may be placed on top of the lower part to reform the mold and enclose the laid up laminated structure.

FIG. 6 is a flow diagram 600 showing representative steps in creating a light weight, high strength, heat resistant composite structure of the present invention.

In Step 601 “CREATE SUBSTRATE” a substrate may be created from a suitable material such as, but not limited to, a polypropylene, a PETG (Polyethylene Terephthalate Glycol). Nylon, a TPU (Thermoplastic Polyurethane) and Acrylonitrile butadiene styrene (ABS).

The substrate material may be shaped to an appropriate or required shape by any suitable well known machining process such as, but not limited to, 3D printing, additive manufacturing, milling, or some combination thereof. The substrate may be solid, semi-solid or hollow. It may, for instance, be in the form of a lattice such as, but not limited to, a honeycomb structure.

In Step 602 “CREATE TWO-PART MOLD” a two-part, or clam shell mold may be created.

This mold may be made of a suitable material such as, but not limited to, plywood or a suitable polymer having properties similar to the substrate. A suitable material may be one that has a coefficient of expansion that is a reasonable match to that of the substrate material and carbon fiber and aramid fabrics. The material may also have good release characteristics, such as, but not limited to, a surface or surface finish that may allow the cured composite structure to be easily separated from it. The mold material may be shaped so that the inner surface conforms to the outer surface of the substrate. Plywood may, for instance, be steam heated and then bent, or molded, to conform to the pattern. Molds may also or instead be machined completely or in part by CNC machine methods. Molds may also or instead be 3D printed or made by additive manufacturing.

In Step 603 “LAYUP LOWER OUTER HOUSING”. In this step one or more layers of aramid fabric may be laid onto a lower part of the two-part mold, thereby creating a lower, outer housing. Prior to laying on the fabric, a release agent may be applied to the inner surface of the mold. The release agent may be a material such as, but not limited to, a wax or a grease that may allow easier separation of the cured composite structure.

In Step 604 “LAYUP LOWER INNER CASING” one or more layers of carbon fiber fabric may be laid onto lower, outer housing to create a lower inner casing.

In Step 605 “PLACE SUBSTRATE” the substrate may be placed onto the lower inner casing.

In Step 606 “LAYUP UPPER INNER CASING”, one or more layers of fiber fabric may be laid onto the core to create an upper inner casing.

In Step 607 “LAYUP UPPER OUTER HOUSING” one or more layers of aramid fabric may be laid onto upper inner casing to create an upper, outer housing. This may complete a laid up composite structure.

In Step 608 “REFORM MOLD” the upper part of the two-part mold may be connected with the lower part, reforming the mold and enclosing the laid up laminated structure.

In Step 609 “CURE” the two-part mold containing the laid up laminated structure may undergo a curing process in order to create a cured composite structure. The curing may, for instance, be accomplished by suitable heating, pressure or time, or some combination thereof.

In Step 610 “REMOVE FROM MOLD”, the two-part mold may be separated, and the cured composite structure may be removed from the mold.

In each of the layup steps in the process, each layer of fabric may be accompanied by an application of a suitable resin, such as, but not limited to, an epoxy resin, a vinyl ester resin, and a polyester resin, or some combination thereof.

Alternately, one or more the layers of fabric may be pre-impregnated fabric, or cured pre-impregnated fabric.

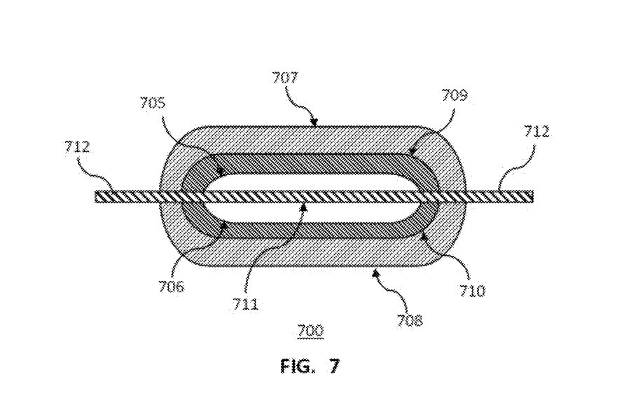

FIG. 7 shows a cross-sectional view 700 of yet another embodiment of a light weight, high strength, heat resistant composite structure.

As shown in FIG. 7, the composite structure may have a lightweight substrate that has an interlayer 711 sandwiched between an upper part of the substrate 705 and a lower part of the substrate 706.

The interlayer 711 may, for instance, be made of any suitable stiff or rigid material such as, but not limited to, aluminum, stainless steel, wood, or plastic or some combination thereof.

The upper and said lower parts of the substrate may be semi-solid and may be made of any suitable material such as, but not limited to, polypropylene, a PETG (Polyethylene Terephthalate Glycol). Nylon, a TPU (Thermoplastic Polyurethane) and Acrylonitrile butadiene styrene (ABS) and balsa wood, or some combination thereof.

The upper and said lower parts of the substrate may, for instance, have a shaped structure such as, but not limited to, a lattice or a honeycomb structure, and may be made using any suitable manufacturing technique such as, but not limited to, 3D printing, additive manufacturing, milling, casting, or some combination thereof.

The upper part 709 and lower part 710 of the inner, strength providing, casing may be made of one or more layers of carbon fiber cloth, as described in more detail above. Similarly, the upper part 707 and the lower part 708 of the outer housing that may provide heat and impact resistance, may be made of one or more layers of aramid fiber cloth, as described in more detail above.

As shown in FIG. 7, the interlayer 711 may have at least one lateral extension 712 extending beyond the upper and lower parts of the outer housing.

These lateral extensions may be useful as the lugs of palettes or dollies as used in, for instance, aircraft loading systems as described in more detail in, for instance, US 4,690,360 entitled “Cargo pallet” issued to Robert Looker on September 01, 1987, which details the construction of a cargo pallet for use in transporting cargo in aircraft, and the contents of which are hereby incorporated by reference in their entirety.

Although this invention has been described with a certain degree of particularity, it is to be understood that the present disclosure has been made only by way of illustration and that numerous changes in the details of construction and arrangement of parts may be resorted to without departing from the spirit and the scope of the invention.

1. A lightweight, high strength, heat resistant , composite structure, comprising:
a lightweight substrate;
an inner, strength providing, casing enclosing said lightweight substrate, said inner casing comprising one or more layers of carbon fiber fabric; and,
an outer housing providing heat and impact resistance enclosing said inner casing, said outer housing comprising one or more layers of aramid fabric.

2. The composite structure of claim 1 wherein said lightweight substrate comprises a 3D-printed substrate.

3. The composite structure of claim 1 wherein said lightweight substrate comprises a semi-solid shaped light weight substrate.

4. The composite structure of claim 3 wherein said semi-solid, shaped lightweight substrate is one of a lattice and a honeycomb structure.

5. The composite structure of claim 3 wherein said semi-solid, shaped lightweight substrate is 3D printed.

6. The composite structure of claim 1 wherein said lightweight substrate comprises one or more layers of foil having an adhesive coating on at least an upper and a lower surface of said composite layers of foil.

7. The composite structure of claim 6 wherein said layers of foil comprise one of a polymer foil, a layer of carbon fiber, an aluminum foil and an iridium foil.

8. The composite structure of claim 1 wherein at least one of said layers of carbon fiber fabric comprises a cured, resin impregnated carbon fiber fabric and at least one of said layers of aramid fabric comprises a cured, resin impregnated carbon fiber fabric.

9. The composite structure of claim 1 wherein said inner, strength providing casing further comprises one or more layers of aramid fiber fabric interleaved with said layers of carbon fiber fabric, and said outer housing providing heat and impact resistance further comprises one or more layers of carbon fiber fabric interleaved with said layers of aramid fiber fabric.

10. The composite structure of claim 9 wherein at least one of said carbon fiber fabric comprises a cured, resin impregnated carbon fiber fabric and at least one of said aramid fabric comprises a cured, resin impregnated carbon fiber fabric.

11. The composite structure of claim 1 wherein said lightweight substrate further comprises an interlayer sandwiched between an upper part of said substrate and a lower part of said substrate.

12. The composite structure of claim 11 wherein said upper and said lower parts of said substrate are semi-solid.

13. The composite structure of claim 11 wherein said upper and said lower parts of said substrate 3D printed.

14. The composite structure of claim 11 wherein said interlayer further comprises at least one lateral extension extending beyond said upper and lower parts of said outer housing.

15. The composite structure of claim 14 wherein said interlayer comprises an aluminum sheet.
